(19) United States
(12) Patent Application Publication
(10) Pub. No.: US 2008/0276497 A1
(43) Pub. Date: Nov. 13, 2008

(54) Modification of polymeric materials for increased adhesion

(76) Inventors: Richard T. Chou, Hockessin, DE (US); Kye Hyun Kim, Seoul (KR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/712,180

(22) Filed: Feb. 28, 2007

Related U.S. Application Data
(60) Provisional application No. 60/777,349, filed on Feb. 28, 2006.

(51) Int. Cl. A43B 13/42; C08J 9/32; A43B 23/08

(52) U.S. Cl. 36/30 A; 523/218; 36/69

(57) ABSTRACT

A method of improving the adhesion of primers and adhesives to the surface of a polymeric material is provided. In this method, the adhesion is improved by modifying the polymeric material with a filler. Preferably, the filler comprises hollow microspheres or nanoparticles. Silica is a preferred filler.

### CROSS-REFERENCE TO RELATED APPLICATION

The present application claims priority under 35 U.S.C. § 120 to U.S. Provisional Appln. No. 60/777,349, filed on Feb. 28, 2006, which is incorporated herein by reference in its entirety.

### FIELD OF THE INVENTION

The invention relates to a method of improving the adhesion between polymeric materials and adhesives or primers. Specifically, a method of improving adhesion by adding filler to the polymeric material is provided.

### BACKGROUND OF THE INVENTION

Several patents and publications are cited in this description in order to more fully describe the state of the art to which this invention pertains. The entire disclosure of each of these patents and publications is incorporated by reference herein.

Many industrial products and consumer goods are made by adhering two or more parts together. These parts may be dissimilar in material, structure, or form. Often, one or more of the parts are polymeric materials. Athletic footwear, for example, may contain several polymeric layers, in the sole of the shoe, for example. The adhesion between these layers is critical to the useful life of the footwear.

Increasing the adhesion between polymeric materials, and between polymeric materials and other materials, is an important goal, therefore. Efforts have been made to improve adhesion to polymers, and the known techniques include the use of adhesives and primers, such as silanes; flame treatments; plasma treatments; electron beam treatments; oxidation treatments; corona discharge treatments; ultraviolet light treatments; and solvent treatments, for example. Other known techniques improve adhesion by creating a rougher surface on one or more of the surfaces to be adhered. These methods include chemical treatments, such as chromic acid treatments; hot air treatments; ozone treatments; and sand blast treatments, for example.

In summary, adhesion between polymeric materials, and between polymeric materials and other materials, is crucial to many industrial and consumer goods. There is a need, therefore, for simple, economical, and effective means of improving the adhesive properties of polymeric materials.

### SUMMARY OF THE INVENTION

According to the present invention, a method of improving the adhesion of primers and adhesives to the surface of a polymeric material is provided. The adhesion is improved by modifying the polymeric material with a filler. In a preferred method of the invention, the filler comprises hollow silica microspheres, nano-fillers, such as silica, titanium dioxide, zinc oxide, zirconium oxide, carbon nanotube, and clay, such as montmorillonites.

### BRIEF DESCRIPTION OF THE DRAWINGS

FIG. 1 is an electron micrograph of the surface of neat Surlyn® 8940 obtained by scanning electron microscopy (SEM) at 5000× magnification.

FIG. 2 is an electron micrograph of the surface of Surlyn® 8940 containing hollow silica microspheres. The image was obtained by SEM at 500× magnification.

FIG. 3 is an electron micrograph of the surface of Surlyn® 8940 containing hollow silica microspheres. The image was obtained by SEM at 1000× magnification.

FIG. 4 is an electron micrograph of the surface of Surlyn® 8940 containing hollow silica microspheres. The image was obtained by SEM at 10,000× magnification.

### DETAILED DESCRIPTION

The following definitions apply to the terms as used throughout this specification, unless otherwise limited in specific instances.

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

The terms “finite amount” and “finite value”, as used herein, refer to an amount that is greater than zero.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

The term “consisting essentially of”, as used herein, means that the composition with respect to which the term is used may include other components that are present as minor impurities.

Finally, all percentages, parts, ratios, and the like set forth herein are by weight, unless otherwise stated in specific instances.

The method of the invention improves the adhesion of adhesives and primers to polymeric materials. The term “polymeric materials”, as used herein, refers to polymers, polymer blends, and polymer composites. Suitable polymeric materials may include one or more of acrylic resins, acrylate resins, methacrylic resins, methyl acrylate resins, polystyrene resins, polyolefin resins, polyethylene resins, polypropylene resins, urethane resins, urea resins, epoxy resins, polyester resins, alkyd resins, polyamide resins, polyamideimide resins, polyvinyl resins, phenoxy resins, nylon resins, amino resins, melamine resins, chlorine-containing resins, chlorinated polyether resins, fluorine-containing resins, polyvinyl acetals, polyvinyl formals, poly(vinyl butyrate)s, polyacetylene resins, poly ether resins, silicone resins, ABS resins, polysulfone resins, polyamine sulfone resins, polyether sulfone resins, polyphenylene sulfone resins, vinyl chloride resins, polyphenylene oxide resins, polypyrrole resins, polyparaphenylene resins, ultraviolet-curing resins, cellulose derivatives, nitrocelluloses, cellulose esters, cellulose acetate butyrates, cellulose acetate propionates, cellulose acetates, diethylene glycol bis-allyl carbonate poly-4-methylpentene, polytetrafluoroethylene, polytrifluoroethylene, polyvinylidene fluoride, polyvinylidene chloride, high density polyethylene, low density polyethylene, linear low density polyethylene, ultralow density polyethylene, polyolefins, poly(ethylene-co-glycidylmethacrylate), poly(ethylene-co-methyl(meth)acrylate-co-glycidyl acrylate), poly(ethylene-co-n-butyl acrylate-co-glycidyl acrylate), poly(ethylene-co-methyl acrylate), poly(ethylene-co-ethyl acrylate), poly(ethylene-co-butyl acrylate), poly(ethylene-co-(meth)acrylic acid), metal salts of poly(ethylene-co-(meth)acrylic acid), poly((meth)acrylates), such as poly(methyl methacrylate), poly(ethyl methacrylate), and the like, poly(ethylene-co-carbon monoxide), poly(ethylene-co-vinyl alcohol), polypropylene, polybutylene, poly(cyclic olefins), polyesters, poly(ethylene terephthalate), poly(1,3-propyl terephthalate), poly(1,4-butylene terephthalate), PETG, poly(ethylene-co-1,4-cyclohexane dimethanol terephthalate), poly(vinyl chloride), polystyrene, syndiotactic polystyrene, poly(4-hydroxystyrene), novalacs, poly(cresols), polyamides, nylons, nylon 6, nylon 11, nylon 12, nylon 46, nylon 66, nylon 612, polycarbonates, poly(bisphenol A carbonate), polysulfides, poly(phenylene sulfide), polyethers, poly(2,6-dimethylphenylene oxide), and polysulfones.

Preferred polymeric materials include polypropylene, polypropylene-based thermoplastic elastomers such as Santoprene™, polyethylene terephthalate, polybutylene terephthalate, acrylonitrile butadiene styrene (ABS), nylon 6, nylon 66, nylon 11, nylon 12, polycarbonate, polyether block amide thermoplastic elastomers such as copolyetheramides (Pebax™, e.g.) and copolyetheresters (Hytrel®, e.g.), and any alloys that are difficult to bond via the application of primers and/or adhesives.

More preferably, the polymeric material includes an ionomer of a copolymer of an olefin and an α,β-unsaturated carboxylic acid. The polymeric material may also consist essentially of an ionomer of a copolymer of an olefin and an α,β-unsaturated carboxylic acid. Suitable acid copolymers are preferably “direct” acid copolymers. The acid copolymers are preferably copolymers of an alpha olefin, more preferably ethylene, with a C3 to C8, α,β ethylenically unsaturated carboxylic acid, more preferably (meth)acrylic acid.

The acid copolymers may optionally contain a third, softening monomer. The term “softening”, as used in this context, refers to a disruption of the crystallinity of the copolymer. Preferred “softening” comonomers are include, for example, alkyl(meth)acrylates wherein the alkyl groups have from about 1 to about 8 carbon atoms.

The acid copolymers, when the alpha olefin is ethylene, can be described as E/X/Y copolymers, wherein E represents copolymerized residues of ethylene, X represents copolymerized residues of an α,β ethylenically unsaturated carboxylic acid, and Y represents copolymerized residues of a softening comonomer. X is preferably present at a level of about 3 to about 30 wt %, preferably about 4 to about 25 wt %, and more preferably about 5 to about 20 wt %, based on the total weight of the acid copolymer. The acid comonomer residues X may be at least partially neutralized by one or more alkali metal, transition metal, or alkaline earth metal cations so that the copolymer is an ionomer. Preferably, about 30 to about 70 mole percent of the acid comonomer residues X are neutralized. Y is preferably present at a level of about 0 to about 30 wt %, based on the total weight of the acid copolymer. Alternatively, Y may be present at a level of about 3 to about 25 wt % or about 10 to about 23 wt %, based on the total weight of the acid copolymer. Preferred acid copolymers consist essentially of copolymerized residues of ethylene, one of more α,β ethylenically unsaturated carboxylic acids, and optionally one or more alkyl acrylates.

Examples of ionomers suitable for use in the present invention include partially neutralized ethylene/(meth)acrylic acid copolymers or ionomers. Also included are ionomers of ethylene/(meth)acrylic acid/n-butyl(meth)acrylate, ethylene/(meth)acrylic acid/iso-butyl(meth)acrylate, ethylene/(meth)acrylic acid/methyl(meth)acrylate, and ethylene/(meth)acrylic acid/ethyl(meth)acrylate terpolymers.

Several preferred ionomers for use in the present invention are commercially available. These include Surlyn® polymers, available from E.I. du Pont de Nemours & Co. of Wilmington, Del., and Escor™ and lotek™ polymers, available from ExxonMobil Chemical Company of Houston, Tex., and the like.

Methods of preparing acid copolymers of ethylene are well known in the art. For example, acid copolymers may be prepared by the method disclosed in U.S. Pat. No. 4,351,931, issued to Armitage. This patent describes acid copolymers of ethylene comprising up to 90 weight percent ethylene. In addition, U.S. Pat. No. 5,028,674, issued to Hatch et al., discloses improved methods of synthesizing acid copolymers of ethylene when polar comonomers such as (meth)acrylic acid are incorporated into the copolymer, particularly at levels higher than 10 weight percent. Finally, U.S. Pat. No. 4,248,990, issued to Pieski, describes the preparation and properties of acid copolymers synthesized at low polymerization temperatures and normal pressures.

Ethylene acid copolymers with high levels of acid (X) are difficult to prepare in continuous polymerizers because of monomer-polymer phase separation. This difficulty can be avoided, however, by use of “co-solvent technology” as described in U.S. Pat. No. 5,028,674, or by employing somewhat higher pressures than those at which copolymers with lower acid can be prepared.

The polymeric materials may further comprise additives or other ingredients that are suitable for use in polymeric compositions. For example, conventional additives include antioxidants, UV stabilizers, flame retardants, plasticizers, dyes, pigments, processing aids, and the like. Suitable levels of these additives and methods of incorporating these additives into polymer compositions will be known to those of skill in the art. See, e.g., the Modern Plastics Encyclopedia, McGraw-Hill, New York, N.Y. 1995.

The method of the invention improves the adhesion of adhesives and primers to polymeric materials. Suitable adhesives and primers include, without limitation, gamma-chloropropylmethoxysilane, vinyltrichlorosilane, vinyltriethoxysilane, vinyltris(beta-methoxyethoxy) silane, gamma-methacryloxypropyl trimethoxysilane, beta-(3,4-epoxycyclohexyl)ethyltrimethoxysilane, gammaglycidoxypropyl trimethoxysilane, vinyl-triacetoxysilane, gamma-mercaptopropyl trimethoxysilane, gamma-aminopropyltriethoxysilane, N-beta-(aminoethyl)-gamma-aminopropyl-trimethoxysilane, glue, gelatine, casein, starch, cellulose esters, aliphatic polyesters, poly(alkanoates), aliphatic-aromatic polyesters, sulfonated aliphatic-aromatic polyesters, polyamide esters, rosin/polycaprolactone triblock copolymers, rosin/poly(ethylene adipate) triblock copolymers, rosin/poly(ethylene succinate) triblock copolymers, poly(vinyl acetates), poly(ethylene-co-vinyl acetate), poly(ethylene-co-ethyl acrylate), poly(ethylene-co-methyl acrylate), poly(ethylene-co-propylene), poly(ethylene-co-1-butene), poly(ethylene-co-1-pentene), poly(styrene), acrylics, Rhoplex N-1031, (an acrylic latex from the Rohm & Haas Company), polyurethanes, AS 390, (an aqueous polyurethane adhesive base for Adhesion Systems, Inc.) with AS 316, (an adhesion catalyst from Adhesion Systems, Inc.), Airflex 421, (a water-based vinyl acetate adhesive formulated with a crosslinking agent), sulfonated polyester urethane dispersions, (such as sold as Dispercoll U-54, Dispercoll U-53, and Dispercoll KA-8756 by the Bayer Corporation), nonsulfonated urethane dispersions, (such as Aquathane 97949 and Aquathane 97959 by the Reichold Company; Flexthane 620 and Flexthane 630 by the Air Products Company; Luphen D DS 3418 and Luphen D 200A by the BASF Corporation; Neorez 9617 and Neorez 9437 by the Zeneca Resins Company; Quilastic DEP 170 and Quilastic 172 by the Merquinsa Company; Sancure 1601 and Sancure 815 by the B. F. Goodrich Company), urethane-styrene polymer dispersions, (such as Flexthane 790 and Flexthane 791 of the Air Products & Chemicals Company), Non-ionic polyester urethane dispersions, (such as Neorez 9249 of the Zeneca Resins Company), acrylic dispersions, (such as Jagotex KEA-5050 and Jagotex KEA 5040 by the Jager Company; Hycar 26084, Hycar 26091, Hycar 26315, Hycar 26447, Hycar 26450, and Hycar 26373 by the B. F. Goodrich Company; Rhoplex AC-264, Rhoplex HA-16, Rhoplex B-60A, Rhoplex AC-234, Rhoplex E-358, and Rhoplex N-619 by the Rohm & Haas Company), silanated anionic acrylate-styrene polymer dispersions, (such as Acronal S-710 by the BASF Corporation and Texigel 13-057 by Scott Bader Inc.), anionic acrylate-styrene dispersions, (such as Acronal 296D, Acronal NX 4786, Acronal S-305D, Acronal S-400, Acronal S-610, Acronal S-702, Acronal S-714, Acronal S-728, and Acronal S-760 by the BASF Corporation; Carboset CR-760 by the B. F. Goodrich Company; Rhoplex P-376, Rhoplex P-308, and Rhoplex NW-1715K by the Rohm & Haas Company; Synthemul 40402 and Synthemul 40403 by the Reichold Chemicals Company; Texigel 13-57, Texigel 13-034, and Texigel 13-031 by Scott Bader Inc.; and Vancryl 954, Vancryl 937 and Vancryl 989 by the Air Products & Chemicals Company), anionic acrylate-styrene-acrylonitrile dispersions, (such as Acronal S 886S, Acronal S 504, and Acronal DS 2285 X by the BASF Corporation), acrylate-acrylonitrile dispersions, (such as Acronal 35D, Acronal 81D, Acronal B 37D, Acronal DS 3390, and Acronal V275 by the BASF Corporation), vinyl chloride-ethylene emulsions, (such as Vancryl 600, Vancryl 605, Vancryl 610, and Vancryl 635 by Air Products and Chemicals Inc.), vinylpyrrolidone/styrene copolymer emulsions, (such as Polectron 430 by ISP Chemicals), carboxylated and noncarboxylated vinyl acetate ethylene dispersions, (such as Airflex 420, Airflex 421, Airflex 426, Airflex 7200, and Airflex A-7216 by Air Products and Chemicals Inc. and Dur-o-set E150 and Dur-o-set E-230 by ICI), vinyl acetate homopolymer dispersions, (such as Resyn 68-5799 and Resyn 25-2828 by ICI), polyvinyl chloride emulsions, (such as Vycar 460×24, Vycar 460×6 and Vycar 460×58 by the B. F. Goodrich Company), polyvinylidene fluoride dispersions, (such as Kynar 32 by Elf Atochem), ethylene acrylic acid dispersions, (such as Adcote 50T4990 and Adcote 50T4983 by Morton International), polyamide dispersions, (such as Micromid 121RC, Micromid 141L, Micromid 142LTL, Micromid 143LTL, Micromid 144LTL, Micromid 321RC, and Micromid 632HPL by the Union Camp Corporation), anionic carboxylated or noncarboxylated acrylonitrile-butadiene-styrene emulsions and acrylonitrile emulsions, (such as Hycar 1552, Hycar 1562×107, Hycar 1562×117 and Hycar 1572×64 by B. F. Goodrich), resin dispersions derived from styrene, (such as Tacolyn 5001 and Piccotex LC-55WK by Hercules), resin dispersions derived from aliphatic and/or aromatic hydrocarbons, (such as Escorez 9191, Escorez 9241, and Escorez 9271 by Exxon), styrene-maleic anhydrides, (such as SMA 1440H and SMA 1000 by AtoChem), and the like and mixtures thereof. Specific examples of the preferable silane adhesives include, for example, gamma-chloropropylmethoxysilane, vinyltriethoxysilane, vinyltris(beta-methoxyethoxy)silane, gamma-methacryloxypropyl methoxysilane, vinyltriacetoxysilane, gamma-glycidoxypropyl trimethoxysilane, gamma-glycidoxypropyltriethoxysilane, beta-(3,4-epoxycyclohexyl)ethyltrimethoxysilane, vinyltrichlorosilane, gamma-mercaptopropyl methoxysilane, gamma-aminopropyl triethoxysilane, N-beta-(aminoethyl)-gamma-aminopropyltrimethoxysilane, and the like and mixtures thereof.

Some preferred adhesives and primers comprise water-based polyurethanes or solvent-based polyurethanes. Other preferred adhesives and primers comprise or consist essentially of water-based chlorinated compound or solvent-based chlorinated compound. The chlorinated compounds are preferably chlorinated polyolefins. Suitable polyurethane adhesives and primers are commercially available, for example from the Dongsung Chemical Co., Ltd., of Busan, Korea.

When using an adhesive or primer, one of ordinary skill in the art will be able to identify appropriate coating thicknesses and process parameters based on the composition of the polymeric material, and of the adhesive or primer, and based on the coating process. Some useful coating conditions and process parameters are set forth in the Examples of the invention, below.

The adhesives and primers may further comprise additives or other ingredients that are suitable for use in such compositions. For example, conventional additives include antioxidants, UV stabilizers, thickeners, rheology modifiers, buffering agents, secondary solvents, and the like. Suitable levels of these additives and methods of incorporating these additives into adhesive and primer compositions will be known to those of skill in the art.

In the method of the invention, the adhesion between adhesives or primers and polymeric materials is improved by adding a filler to the polymeric material. Without wishing to be held to any theory, it is believed that certain fillers are capable of forming small holes, depressions or “microvoids” on the surface of the modified polymeric material. These microvoids are believed to be favorable to adhesion.

Suitable fillers include inorganic and organic fillers, such as, for example, gypsum, talc, mica, carbon black, wollastonite, montmorillonite minerals, chalk, diatomaceous earth, sand, aerogels, xerogels, microspheres, porous ceramic spheres, gypsum dihydrate, calcium aluminate, magnesium carbonate, ceramic materials, pozzolamic materials, zirconium compounds, xonotlite (a crystalline calcium silicate gel), perlite, vermiculite, hydrated or unhydrated hydraulic cement particles, pumice, perlite, zeolites, kaolin, clay fillers, including both natural and synthetic clays and treated and untreated clays, such as organoclays and clays that have been surface treated with silanes and stearic acid to enhance adhesion with the copolyester matrix, smectite clays, magnesium aluminum silicate, bentonite clays, hectorite clays, silicon oxide, calcium terephthalate, aluminum oxide, titanium dioxide, iron oxides, calcium phosphate, barium sulfate, sodium carbonate, magnesium sulfate, aluminum sulfate, magnesium carbonate, barium carbonate, calcium oxide, magnesium oxide, aluminum hydroxide, calcium sulfate, barium sulfate, lithium fluoride, powdered metals, calcium carbonate, calcium hydroxide, glass beads, hollow inorganic beads, hollow glass beads, glass fibers, carbon fibers, graphite fibers, silica fibers, ceramic fibers, and the like. Also included are combinations of one or more suitable fillers.

Preferably, the filler comprises or consists essentially of silica, titania, zinc oxide, zirconia, alumina, carbon nanotubes, or clays, such as montmorillonites. Also preferably, the filler comprises or consists essentially of hollow inorganic particles or nanoparticles (“nano-fillers”). More preferably, the filler comprises or consists essentially of silica, and still more preferably hollow particles or hollow nanoparticles of silica. Fumed silica or nanosilica is particularly preferred. Such fillers are commercially available.

The preferred fillers may come with different shapes and aspect ratio. For example, montmorillonite has a plate structure with individual platelets being roughly 1 nanometer (nm) thick and 100 to 1000 nm across.

Preferably, however, the fillers are nano-fillers. The primary particle size of the preferred nano-fillers is about 1 to 150 nanometer (nm). For some nano-fillers, due to the diffusion aggregation limited process, primary particles with size in the range of 1 to 150 nm tend to stick together to form aggregates. The preferred average particle size of the aggregates is the range of 0.1 to 2 microns. For example, fumed silica has a primary particle size of about 5 to 100 nm; however, it mainly exists in aggregate form with size of 0.1 to 1.0 micron.

Preferred nano-fillers include silica, titanium dioxide, zinc oxide, zirconium oxide, carbon nanotube, and clay, such as montmorillonites. hydrotalcite and octosilicate, and the like. More preferred nano-fillers comprise or consist essentially of synthetic amorphous silica. The advantages of using nano-sized silica (“nanosilica”) include a relatively low price, wide commercial availability, and a greater variety of particle shapes and sizes compared with other nano-fillers, such as clay and carbon nano-tubes.

The two principal synthetic routes to produce synthetic amorphous silica are the wet route of sol/gel processing and the thermal route of pyrogenic processing. Descriptions of the synthetic techniques and forms of nanosilica produced by sol/gel processes may be found in U.S. Pat. Nos. 2,801,185; 4,522,958 and 5,648,407, for example.

Fumed silica is a preferred nanosilica that is made via the thermal route, by pyrogenic processing. Suitable fumed nano-silicas are commercially available in both hydrophilic (surface unmodified) and hydrophobic (surface modified) varieties. For example, Degussa AG of DOsseldorf, Germany is the supplier of Aerosil products, such as Aerosil R 7200, Aerosil R 711, Aerosil 200 (unmodified), Aerosil R 104, and the like. The Cabot Corporation of Billerica, Mass., is the supplier of Cab-O-Sil TS-720, Cab-O-Sil TS-610, Cab-O-Sil TS-530, and the like. Wacker Chemie AG of Munich, Germany, is the supplier of Wacker HDK V15, Wacker HDK N20, Wacker HDK T30, Wacker H2000 (unmodified), and the like.

Hollow silica particles, also commonly referred to as cenospheres or hollow glass beads, is also a particularly preferred microvoid-forming filler for use in the present invention. In general, it is preferable, although not essential, that the hollow silica particles be substantially spherical. Accordingly, the particles are sometimes referred to as “microspheres.” This term, as used herein, does not imply that the particles are perfectly spherical. Also preferably, the hollow silica has a bulk density of approximately 0.1 to 0.5 g/cm³. Hollow silica particles are known, and have been used as fillers. See, for example, International Appln. Publn. No. WO03/093542, by Kim et al., U.S. Patent Appln. Publn. No. 2004/0082673, by Rajat K. Agarwal, and U.S. Pat. No. 5,512,094, issued to Howard. R. Linton. Methods for producing hollow silica nanoparticles are also described in Japanese Patent Nos. JP-A-2001/233611 and JP-A-2002/79616.

The filler or nanofiller is present in the polymeric material in a finite amount, preferably at a level of about 0.2 to about 20 wt %, more preferably 0.3 to about 10 wt %, and still more preferably at a level of about 0.5 to about 5 wt %, based on the total weight of the silica and the polymeric material.

The selection of a filler, and the preferred particle size, particle shapes, and size distribution of the filler depend on the desired properties of the modified polymeric material. For example, when Surlyn® is the modified polymeric material, transparency is often a desirable property. Therefore, the size of the filler particles should not be so large that the Surlyn® takes on a cloudy or opaque appearance. Nanofillers may therefore be preferred for applications requiring optical transparency. Owing to the relatively low refractive index of silica, fumed silica and hollow silicates are also preferred for retaining high transparency in Surlyn® parts. Nanosilicas and hollow silica nanoparticles are more preferred for use in such applications.

The surfaces of the fillers may be modified for various reasons. For example, silica is hydrophilic by nature; chemical modification, however, can render the surface more hydrophobic or change its degree of reactivity. The surface modification is known in the art, and is generally accomplished by treating the silica with organo-silanes, which react with the silanol sites of the silica.

Also optionally, the fillers may be coated with a dispersing agent or “dispersant”, compatibilizer, or other coating, such as tetraethyl orthosilicate (TEOS). Such coatings may be useful to enhance the physical properties of the modified polymeric material. Dispersing agents, whether coated onto the filler particles or added by another method to the blend of filler and polymeric material, may be used to facilitate the incorporation of the filler into the polymeric material. Many dispersion agents and compatibilizing agents are known to be effective in aiding the dispersion of fillers, and, in particular, nanofillers into polymeric materials.

Suitable dispersing agents include maleic anhydride grafted polyolefins. The polyolefins refer to polyethylene such as high density polyethylene (HDPE), linear low density polyethylene (LLDPE), metallocene-produced polyethylene (MPE) or other single-site catalyst produced polyethylene and the like; ethylene copolymers, such as copolymers of ethylene and vinyl acetate; and polypropylene and copolymers of propylene. Grafted polyolefins are well known in the art and can be produced by a variety of processes including thermal grafting in an extruder or other mixing device, grafting in solution. See, for example, U.S. Pat. No. 6,462,122.

Low molecular weight surfactants can also be used for dispersing nannofillers with high hydrogen bonding, such as untreated fume silica. The preferred surfactants are selected from the group of glycerin monostearate, glycerin distearate, diglycerin monostearate, diglycerin distearate, glycerin monooleate, sorbitan monostearate, sorbitan monopalmitate, sorbitan monooleate, and mixtures of two or more preferred surfactants.

Suitable dispersion agents are not restricted to a certain class of materials or surfactants. The selection of a dispersant or surfactant is highly dependent on the chemical nature of both the filler and the polymeric material. An optimal dispersion agent will aid good dispersion and produce desirable surface properties without sacrificing the physical properties that are required in the polymeric material for the intended applications.

The fillers or nanofillers may be added to polymeric materials by methods that will be familiar to those of skill in the art. See, e.g., the Modern Plastics Encyclopedia. For example, blending fumed silica with a melted polymeric material, as part of an extrusion process, is a preferred method of introducing the silica into the polymeric material. The silica may be added directly or via a concentrate or “masterbatch.” Addition via a concentrate is preferred.

The methods described herein are of general use in applications in which articles made of polymeric materials are secured to other articles using adhesives. In general, adhesion via adhesives is preferred when the articles to be adhered should not be distorted, as by accomplishing the adhesion through thermal processing, for example. This is most often the case when the articles are prefabricated in the shape or size that is specified for the article in its end use application. One example of such an article is the sole of a shoe that is prefabricated in a shape that is appropriate for use in a shoe of a particular size.

More specifically, the methods described herein are useful in enhancing the adhesion of polymeric materials comprising or consisting essentially of ionomers of ethylene acid copolymers. In a preferred method of the invention, an article produced from polymeric material that comprises or consists essentially of an ionomer is modified with a nanofiller, such as a nanosilica. The article is preferably secured with an adhesive to a second article produced from a polymeric material that may be the same or different from the polymeric material in the first article. The second article may contain a polymeric material that is modified with the same filler, or with a different filler from the one that is present in the first article. Preferably, the adhesive comprises a water-based or solvent based polyurethane. Preferably, the other article comprises fabricated parts of rubber, foam, fabrics or other polymeric materials. The other polymeric materials include, without limitation, those described above with respect to materials whose adhesion to adhesives and primers may be improved.

Examples of specific articles that may be secured to other articles with adhesives include the soles of shoes. In particular, the soles of athletic shoes may be multilayered structures in which one or more component layers may be adhered to each other by adhesives. One or more of these component layers may comprise or consist essentially of ionomers. Adhesives or primers are also commonly used to secure the soles of shoes to other parts. These other parts may also comprise or consist essentially of ionomers. Other parts of the shoes that may comprise or consisting essentially of ionomers include, without limitation, torsional bars, heel counters and toe puffs.

The following examples are provided to describe the invention in further detail. These examples, which set forth a preferred mode presently contemplated for carrying out the invention, are intended to illustrate and not to limit the invention.

### EXAMPLES

### Adhesion Measurements

### Control Example

Test specimens (150 mm×120 mm×2 mm) of Surlyn® 8940 were formed by injection molding at about 210° C. to 230° C. The test specimens were first cleaned with warm water, then a water-based polyurethane primer (Dongsung NSC W-104) was applied to the test specimens, which were then dried at 50 to 55° C. in an oven. A water-based polyurethane adhesive (Dongsung NSC W-01) was then applied to the primed test specimens, which were subsequently dried at 50° C. for three minutes. Then the specimens were molded with polybutadiene rubber at a pressure of 38 kg/cm for 12 seconds, prior to measuring the peel strength. The rubber was primed with a primer based on a chlorinated compound (Dongsung D-PLY 007) and then with then a water-based polyurethane primer (Dongsung NSC W-104). The bonding strength of each specimen towards rubber as measured by the peel strength was less than 1.5 kg/cm. This low level of bonding is not acceptable for many practical applications.

### Example 1

Test specimens (150 mm×120 mm×2 mm) of Surlyn® 8940 containing 2 wt % of a hollow silicate filler provided by the Nanotech Ceramic Co. of South Korea were formed by injection molding at about 210° C. to 230° C. The specimens were cleaned, dried, and primed according to the procedures described above for the Control Example. Likewise, the rubber was primed according to the procedures described above. The bonding strength of the specimens towards rubber as measured by their peel strength is in the range of 5 to 7 kg/cm.

### Scanning Electron Microscopy

The figures are electron micrographs obtained by scanning electron microscopy (SEM). The scanning electron microscope was a Model S-4700 Field Emission Scanning Electron Microscope available from the Hitachi Company.

The samples were the injection molded, unprimed plaques prepared for the adhesion tests, above. The samples were prepared by evaporating carbon onto their surfaces under a vacuum. Next, the samples were affixed to a metal stub and placed in the SEM apparatus. The sample surfaces were imaged at a tilt angle of 15 or 45 degrees. The SEM was run at low kV primary electron beam current, for minimum penetration of the beam into the samples.

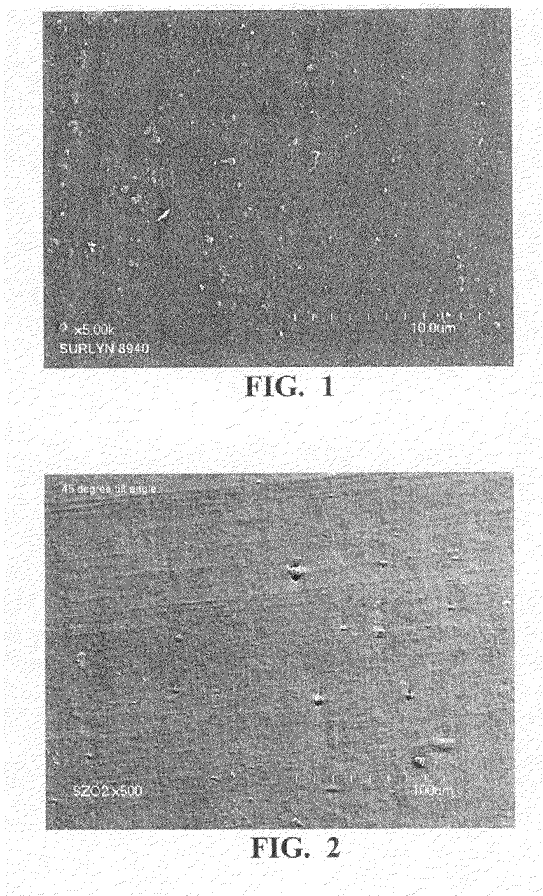

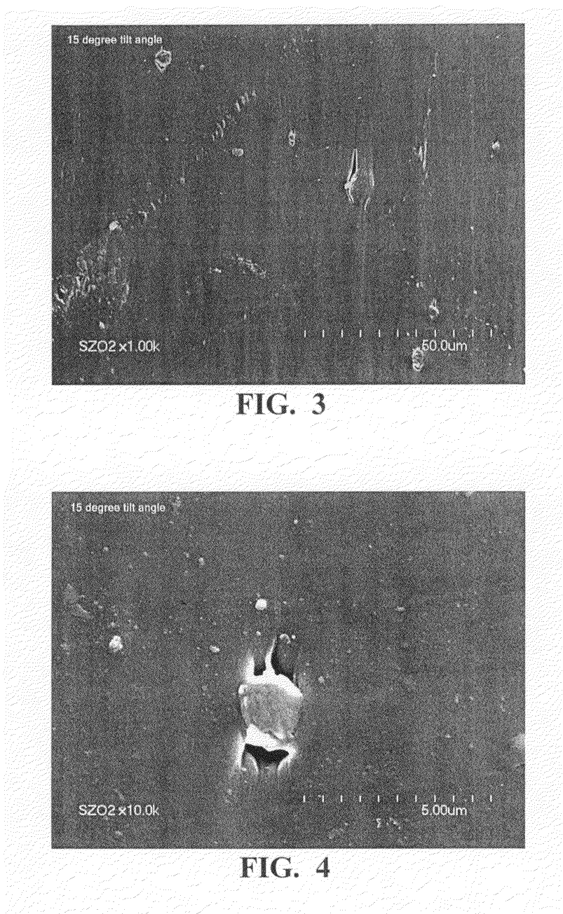

FIG. 1 depicts a plaque of neat Surlyn® 8940, and FIGS. 2, 3, and 4 depict a plaque of Surlyn® 8940 including 2 wt % of hollow silica filler. FIGS. 2, 3, and 4 depict the same portion of the same plaque at three different magnifications, 500×, 100×, and 10,000×, respectively.

The electron micrographs demonstrate that the surface of the neat Surlyn® is relatively uniform, with only a few small protrusions or bumps. See FIG. 1. In contrast, small holes only a few microns in diameter (“microvoids”) are associated with the hollow silica particles and distributed relatively evenly over the surface of the filled Surlyn®. See FIGS. 2, 3, and 4.

### Surface Tension Measurements

The surface tension or surface energy of the plaques prepared above was measured using a Video Contact Angle System instrument available from AST Products, Inc., of Billerica, Mass. Surface tension was calculated according to the Harmonic Mean method, as described in Polymer Interface and Adhesion, Sougeng Wu, Marcel Dekker, Inc. (New York, 1982). Deionized water having a surface tension of 71.8 dynes/cm and methylene iodide having a surface tension of 50.8 dynes/cm were used in the contact angle measurements.

The surface tension of the neat Surlyn® 8940 plaque was 37.6 dynes/cm, whereas the surface tension of the Surlyn® 8940 including hollow silica was 36.4 dynes/cm. Thus, there is no large difference in surface tension that might account for the more favorable wetting behavior of the Surlyn® modified with hollow silica.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A method of modifying a polymeric material so as to increase its adhesion to primers or adhesives comprising the steps of:
a. adding a filler to the polymeric material to create a modified polymeric material, wherein the filler is associated with microvoids in the surface of the modified polymeric material; and
b. contacting the modified polymeric material with an adhesive or primer.

2. The method of claim 1, wherein the filler comprises one or more fillers selected from the group consisting of silica, titania, zinc oxide, zirconia, alumina, carbon nanotubes, and clays.

3. The method of claim 1, wherein the filler comprises nanoparticles or hollow silica nanoparticles having a diameter of about 1 to about 100 nm or wherein the aggregate particle size is about 0.1 to 2 microns.

4. The method of claim 1, wherein the filler comprises silica particles that have one or more of the properties of being solid, hollow, or nano-sized.

5. The method of claim 1, wherein the surface of the filler particles is treated to increase their hydrophilicity or hydrophobicity.

6. The method of claim 1, wherein the polymeric material comprises one or more of polypropylene, polypropylene-based thermoplastic elastomer, polyethylene terephthalate, polybutylene terephthalate, acrylonitrile butadiene styrene, nylon 6, nylon 66, nylon 11, nylon 12, polycarbonate, polyether block amide thermoplastic elastomer, copolyetherester thermoplastic elastomer, or an ionomer of an ethylene acid copolymer.

7. The method of claim 1 wherein the adhesive or primer is selected from the group consisting of gamma-chloropropylmethoxysilane, vinyltriethoxysilane, vinyltris(beta-methoxyethoxy)silane, gamma-methacryloxypropyl methoxysilane, vinyltriacetoxysilane, gamma-glycidoxypropyl trimethoxysilane, gamma-glycidoxypropyltriethoxysilane, beta-(3,4-epoxycyclohexyl)ethyltrimethoxysi lane, vinyltrichlorosilane, gamma-mercaptopropyl methoxysilane, gamma-aminopropyl triethoxysilane, N-beta-(aminoethyl)-gamma-aminopropyltrimethoxysilane, and the like and mixtures thereof.

8. The method of claim 1, wherein the adhesive or primer comprises one or more of a water-based polyurethane, a solvent-based polyurethane, a water-based chlorinated polyolefin or a solvent-based chlorinated polyolefin.

9. An article comprising a modified ionomer composition, said modified ionomer composition comprising an ionomer of an ethylene acid copolymer and a nano-filler, wherein:
the nano-filler is associated with microvoids in the surface of the article;
the nano-filler has a diameter of about 1 nm to about 100 nm;
the surface of the nano-filler particles is optionally treated to increase their hydrophilicity or hydrophobicity; and
the nano-filler is present in the composition in an amount that increases the adhesion of the article to an adhesive or primer, as compared to the adhesion of the adhesive or primer to an article that comprises the ionomer and that does not comprise the nano-filler.

10. The article of claim 9, wherein the nano-filler comprises one or more fillers selected from the group consisting of silica, titania, zinc oxide, zirconia, alumina, carbon nanotubes, and clays.

11. The article of claim 9, wherein the nano-filler comprises silica nanoparticles that are solid or hollow.

12. The article of claim 9, wherein the surface of the nano-filler particles is treated to increase their hydrophilicity or hydrophobicity.

13. The article of claim 9, wherein the polymeric material comprises one or more of polypropylene, polypropylene-based thermoplastic elastomer, polyethylene terephthalate, polybutylene terephthalate, acrylonitrile butadiene styrene, nylon 6, nylon 66, nylon 11, nylon 12, polycarbonate, polyether block amide thermoplastic elastomer, copolyetherester thermoplastic elastomer, or an ionomer of an ethylene acid copolymer.

14. The article of claim 9, wherein the adhesive or primer is selected from the group consisting of gamma-chloropropylmethoxysilane, vinyltriethoxysilane, vinyltris(beta-methoxyethoxy)silane, gamma-methacryloxypropyl methoxysilane, vinyltriacetoxysilane, gamma-glycidoxypropyl trimethoxysilane, gamma-glycidoxypropyltriethoxysilane, beta-(3,4-epoxycyclohexyl)ethyltrimethoxysilane, vinyltrichlorosilane, gamma-mercaptopropyl methoxysilane, gamma-aminopropyl triethoxysilane, N-beta-(aminoethyl)-gamma-aminopropyltrimethoxysilane, and the like and mixtures thereof.

15. The article of claim 9, wherein the adhesive or primer comprises one or more of a water-based polyurethane, a solvent-based polyurethane, a water-based chlorinated polyolefin or a solvent-based chlorinated polyolefin.

16. A shoe comprising a component that comprises a polymeric material and a filler, wherein the filler is associated with microvoids in the surface of the component; and further wherein said component is in direct contact with an adhesive or primer, and said component is at least partially secured to a second component of the shoe by the adhesive or primer.

17. The shoe of claim 16, wherein the polymeric material comprises one or more of polypropylene, polypropylene-based thermoplastic elastomer, polyethylene terephthalate, polybutylene terephthalate, acrylonitrile butadiene styrene, nylon 6, nylon 66, nylon 11, nylon 12, polycarbonate, polyether block amide thermoplastic elastomer, copolyetherester thermoplastic elastomer, or an ionomer of an ethylene acid copolymer.

18. The shoe of claim 16, wherein the adhesive or primer wherein the adhesive or primer comprises one or more of a water-based polyurethane, a solvent-based polyurethane, a water-based chlorinated polyolefin or a solvent-based chlorinated polyolefin.

19. The shoe of claim 16, wherein the filler comprises one or more fillers selected from the group consisting of silica, titania, zinc oxide, zirconia, alumina, carbon nanotubes, and clays.

20. The shoe of claim 16, wherein the filler comprises nanoparticles or hollow nanoparticles having a diameter of about 1 to about 100 nm.

21. The shoe of claim 16, wherein the filler comprises silica particles that have one or more of the properties of being solid, hollow, or nano-sized.

22. The shoe of claim 16, wherein the surface of the filler particles is treated to increase their hydrophilicity or hydrophobicity.

23. The shoe of claim 16, wherein the shoe comprises a sole, wherein the sole comprises at least two layers, and wherein the component and the second component are layers of the sole.

24. The shoe of claim 16, wherein the component is a torsional bar, a heel counter, or a toe puff.

25. The shoe of claim 16, wherein the component comprises an ionomer of an ethylene acid copolymer.
